(19) United States
(12) Patent Application Publication
(10) Pub. No.: US 2008/0238298 A1
(43) Pub. Date: Oct. 2, 2008

(54) IMAGE DISPLAY DEVICE

(76) Inventors: Hironori Asai, Yokohama-shi (JP); Iwao Mitsuishi, Machida-shi (JP); Naotoshi Matsuda, Chigasaki-shi (JP); Keiko Albessard, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/857,179

(22) Filed: Sep. 18, 2007

(30) Foreign Application Priority Data
Mar. 28, 2007 (JP) 2007-085711

(51) Int. Cl. H01J 1/62; H01J 9/02

(52) U.S. Cl. 313/503; 445/24

(57) ABSTRACT

An image display device is provided, which includes a first substrate having a cold-cathode electron-emission element which emits electrons, and a second substrate which is spaced from and opposed to the first substrate. The second substrate has a transparent substrate, a light-emitting layer provided on the transparent substrate and including phosphor particles containing zinc sulfide as a base material, a boron nitride film disposed on a surface of the light-emitting layer, and an anode applying a voltage to the light-emitting layer.

### CROSS-REFERENCE TO RELATED APPLICATIONS

This application is based upon and claims the benefit of priority from prior Japanese Patent Application No. 2007-085711, filed Mar. 28, 2007, the entire contents of which are incorporated herein by reference.

### BACKGROUND OF THE INVENTION

1. Field of the Invention

The present invention relates to an image display device and a method of manufacturing thereof.

2. Description of the Related Art

As the demand for larger-sized image display areas and thinner display sections grows, flat panel displays (FPDs) have been developed. Examples of FPDs are liquid crystal displays (LCDs), electroluminescent displays (ELDs), and plasma display panels (PDPs). Also proposed are cold cathode field emission displays (FEDs), which emit electrons from a solid into a vacuum by using quantum tunneling.

An example of an electron source for FED is Spindt type emitters having a small radius of curvature. Further, there is an image display device using a surface-conduction electron-emitter device (SED) which has a narrow distance between electrodes and emits electrons in the horizontal direction, and part of which is used for light emission with an anode electric field.

In cathode ray tube televisions, electron guns are subjected to aging after manufacturing to increase stability of the electron source, and degassing from a phosphor surface is performed to suppress change in a light-emitting state thereof over time. In aging, electron guns are operated under conditions exceeding usage conditions, and impurities adhering to the surface and entering into the film are removed. Impurity gas is adsorbed by an adsorbent such as getter to prevent deterioration in performance due to reaction with such impurities during use of the product. Although aging is also performed in field emission displays, an electron-beam irradiating area of field emission displays does not spread over the whole surface thereof and an irradiation density of electron beams is nonuniform, unlike cathode-ray-tube televisions. Therefore, in field emission displays, effect of aging is not obtained for a short time.

To suppress decrease in brightness of phosphor even under severe high energy density irradiation environment, it has been proposed to coat the surface of the phosphor layer with a thin film formed of a metal oxide or silicon nitride. In this technique, it is possible to suppress decrease in brightness of the phosphor film.

Further, it is proposed to prevent deterioration of the surface of the phosphor by adhering metal nitride particles to the surface of phosphor particles.

Aging is an important process for stabilization of products, and it is economically important to shorten the time required for aging. When field emission displays are manufactured as image displays such as televisions, aging cannot be sufficiently economically performed only by conventional methods for dealing with deteriorations.

### BRIEF SUMMARY OF THE INVENTION

An image display device according to one aspect of the present invention comprises:

a first substrate having a cold-cathode electron-emission element which emits electrons; and

a second substrate which is spaced from and opposed to the first substrate, the second substrate having a transparent substrate, a light-emitting layer provided on the transparent substrate and including phosphor particles containing zinc sulfide as a base material, a boron nitride film disposed on a surface of the light-emitting layer, and an anode applying a voltage to the light-emitting layer.

A method for manufacturing an image display device according to one aspect of the present invention comprises:

forming a light-emitting layer including phosphor particles containing zinc sulfide as a base material on a glass substrate for an anode; and

forming a boron nitride film on the light-emitting layer by pulse laser deposition.

### BRIEF DESCRIPTION OF THE SEVERAL VIEWS OF THE DRAWING

FIG. 1 is a diagram of a display device according to one embodiment, a part of which is cut away.

FIG. 2 is a schematic diagram illustrating a phosphor screen.

FIG. 3 is a cross-sectional view of a face substrate.

FIG. 4 is a schematic diagram illustrating a structure of a phosphor film according to the embodiment.

FIG. 5 is a schematic diagram illustrating a structure of a phosphor film according to comparative examples.

FIG. 6 is a graph illustrating a relationship between radiated charge amount and brightness maintenance ratio.

FIG. 7 is a graph illustrating a relationship between radiated charge amount and brightness maintenance ratio.

FIG. 8 is a graph illustrating a relationship between wavelength and relative brightness.

FIG. 9 is a cross-sectional view of the display device according to the embodiment.

FIG. 10 is a top view of an emitter element.

FIG. 11 is a cross-sectional view of a display device according to another embodiment.

FIG. 12 is a top view of an emitter element.

FIG. 13 is a cross-sectional view of a rear substrate.

FIG. 14 is a graph illustrating a relationship between wavelength and relative brightness.

FIG. 15 is a graph illustrating a relationship between wavelength and relative brightness.

### DETAILED DESCRIPTION OF THE INVENTION

Embodiments are explained below with reference to drawings.

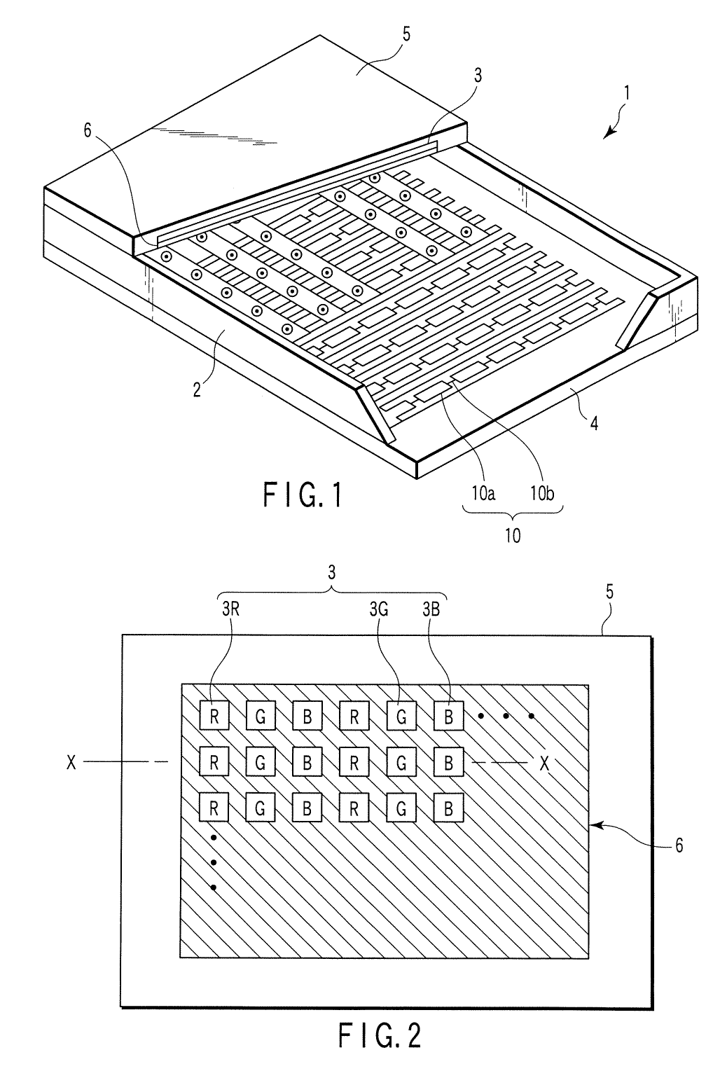

As illustrated in FIG. 1, in an image display device according to one embodiment, a rear substrate 4 formed of a substrate and a face substrate 5 formed of a transparent substrate such as a glass substrate are opposed to each other in parallel, with a predetermined space therebetween. A sidewall 2 is provided at edge portions of the rear substrate 4 and the face substrate 5 to seal the space between the two substrates.

A number of emitter elements (cold-cathode field-emission element) 10 (for example, electron-emission elements of surface-conduction electron emitter (SCE) type) 10 are formed in rows and columns on the rear substrate 4. Each emitter element 10 is formed of an element electrode 10a formed of a thin film, and an electron-emitting part 10b.

A phosphor screen 3 is formed on a surface of the face substrate 5, facing the emitter elements 10. The phosphor screen 3 has layers including phosphor particles, which is struck by electrons emitted from the emitter elements 10 and thereby emit light. The phosphor screen 3 has a layer including blue light-emitting phosphor particles, a layer including green light-emitting phosphor particles, and a layer including red light-emitting phosphor particles, in association with pixels. These layers are separated from each other by black conductive materials (not shown). Usually, at least one emitter element 10 is associated with one pixel of the screen 3, as described later.

The phosphor screen 3 is covered with a metal back layer 6. According to the size of the image display device, a support thin substrate (not shown) may be provided between the rear substrate 4 and the face substrate 5 to bear the load applied to the substrates.

The blue, green and red light-emitting phosphor layers and the black conductive materials separating them are alternately formed in the horizontal direction. The part where the phosphor layers and the black conductive materials exist serves as an image display area. The phosphor layers and black conductive materials can be provided with various structures.

The metal back layer 6 is formed of a conductive thin film such as an Al film. The metal back layer 6 has a function of reflecting light which travels toward the rear substrate 4 serving as an electron source, among light generated by the phosphor layers in the phosphor screen 3, and increasing brightness. Further, the metal back layer 6 provides conductivity to the image display area of the face substrate 5, to prevent accumulation of charge, and stabilizes electric potential of the display panel. Specifically, the metal back layer 6 functions as an anode for the electron source of the rear substrate 4.

The rear substrate 4 has an insulating substrate formed of glass or ceramic, or a substrate formed of Si, and a number of emitter elements 10 formed on the substrate. The emitter elements 10 have, for example, an field-emission cold cathode and surface-conduction electron-emitters. Interconnects (not shown) are provided on the surface of the rear substrate 4 on which the electron emitter elements 10 are formed. Specifically, the emitter elements 10 are formed in rows and columns in association with phosphor particles of the pixels, and there are provided interconnects (X-Y interconnects) which cross each other and drive the emitter elements 10 line by line.

The sidewall 2 airtightly seals the space between the face substrate 5 and the rear substrate 4. The sidewall 2 is bonded to the face substrate 5 and the rear substrate 4, with a bonding material such as frit glass, In or an alloy thereof interposed therebetween. A vacuum vessel serving as an enclosure is formed by the face substrate 5, the rear substrate 4, and the sidewall 2. The sidewall 2 is provided with signal input terminals and line selection terminals (not shown). The terminals correspond to the crossing interconnects (X-Y interconnects) of the rear substrate 4.

When flat-type field-emission displays have a large size, there is the possibility that deformation occurs. To prevent deformation and provide strength against atmospheric pressure, a reinforcing material (atmospheric pressure support thin substrate, spacer) may be provided between the face substrate 5 and the rear substrate 4, in accordance with the intended strength.

Since the emitter elements 10 are operated in a vacuum, the inside of the enclosure formed of the face substrate 5, the rear substrate 4 and the sidewall 2 must be maintained at a high vacuum (for example, with the pressure of 1×10⁻⁵ Pa or less). Therefore, when the enclosure is assembled, it is necessary to maintain sufficient strength and hermeticity in joint portions of the members, and sealing is performed by using frit glass. For example, after frit glass is applied to each of joint portions of the members, the enclosure is put into an electric furnace and heated to a temperature equal to or more than a melting point of the frit glass in the atmosphere to perform sealing.

After sealing is finished, baking is performed while the inside of the enclosure is evacuated to vacuum by a small exhaust tube provided to the rear substrate 4, to sufficiently perform degassing. Thereafter, the end portion of the small exhaust tube is sealed, and getter processing is performed in closing. As described above, through steps such as exhaustion, degassing and aging, the image display device illustrated in drawings is manufactured.

In such image display devices, the size of the emitter elements 10 is of the order of micrometer, and the interval between the rear substrate 4 and the face substrate 5 can be set to the order of millimeter. Therefore, increase in resolution, and reduction in weight and thickness can be achieved, in comparison with cathode ray tubes currently used as displays of televisions and computers.

In image display devices using these electron sources, electron sources equal to or more than the number of light-emitting points are arranged in a plane direction, and an anode substrate having a light-emitting layer which is excited and emits light by acceleration electrons is disposed in a space opposed to the electron source. Since both cathodes and anodes causes electron emission with large electric field strength, the distance between the cathodes and anodes is about several millimeters.

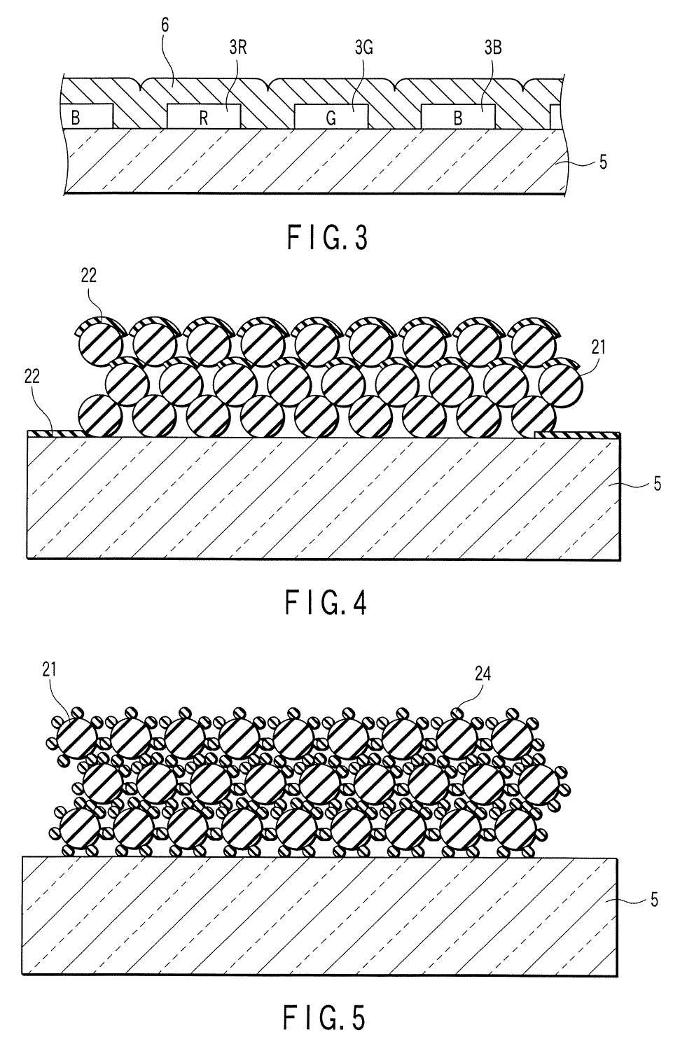

As illustrated in FIG. 2, the phosphor screen 3 includes a red phosphor film 3R, a green phosphor film 3G, and a blue phosphor film 3B. Each phosphor is excited by electrons emitted from the electron sources. Green and blue phosphor particles are mainly formed of zinc sulfide (ZnS), and contain at least one of Cu, Au and Ag as an activator, and at least one of aluminum (Al), chlorine (Cl), bromine (Br) and iodine (I) as a co-activator. Further, red phosphor is rare-earth oxysulfide phosphor such as europium-activated yttrium oxysulfide (Y₂O₂S: Eu). FIG. 3 illustrates a cross-sectional view taken along line X-X in FIG. 2.

In the embodiment, the green phosphor films 3G and the blue phosphor films 3B mainly formed of zinc sulfide are coated with a boron nitride film formed by pulse laser deposition (PLD). Thereby, even when the phosphors are exposed to electron beam of high density, early deterioration (aging) due to adsorbed gas is suppressed. FIG. 4 schematically illustrates this state. As illustrated in FIG. 4, phosphor particles 21 are superposed on the face substrate 5 to form a phosphor film (light-emitting layer), and a boron nitride film 22 is provided on the phosphor film. Since the boron nitride film 22 is formed by PLD, the boron nitride film 22 is also provided on part of the substrate 5 on which phosphor particles 21 do not exist.

The phosphor film is formed by using zinc-sulfide-based phosphors by precipitation or printing. The zinc-sulfide-based phosphors contain zinc sulfide as a base material, and contain at least one activator selected from the group consisting of Cu, Au and Ag, and at least one co-activator selected from the group consisting of Al, Cl, Br and I. More specifically, examples are ZnS: Cu. Al, ZnS: Ag. Al, ZnS: Ag. Al. Au, and ZnS: Ag. Cl. Particles of the phosphors preferably have an average particle diameter of 2 to 10 μm. The average particle diameter of the phosphor particles is determined by method such as blaine air permeability method or laser microtrack. When the average particle diameter falls within a range from 2 to 10 μm, it is possible to manufacture films having sufficient brightness for an image display device. The average particle size of phosphor particles is more preferably 5 to 6 μm.

When a phosphor film is prepared by precipitation, first, a water glass aqueous solution and a binder aqueous solution are prepared. Water glass indicates sodium silicate. Predetermined phosphor particles are dispersed into the water glass aqueous solution, and stirred by a stirrer. An example of a binder is barium nitrate. Such a binder is dissolved in water such as pure water to prepare a binder aqueous solution.

A glass substrate is immersed and kept stationary in the binder aqueous solution, and water glass including dispersed phosphor particles is added to the solution. The phosphor particles precipitate with a reaction product of the binder and the water glass.

Lastly, the glass substrate is dried in the atmosphere at 60 to 120° C. to remove moisture, and thereby a phosphor film is obtained.

In printing method, for example, a paste mainly containing black pigment such as carbon is applied to a glass substrate by screen printing. After a stripe light-absorbing layer is formed, three-color stripe phosphor films of red (R), green (G) and blue (B) are formed by screen printing between patterns of the light-absorbing layer. ZnS:Ag. Al, ZnS:Cu. Al, and Y₂O₂S:Eu are used as the blue phosphor, the green phosphor, and the red phosphor, respectively. Each phosphor is dispersed into an organic material to obtain a paste, and screen printing is performed by using the paste. The organic material is prepared by, for example, dissolving acrylic resin in an alcohol-based solvent. The films formed by screen printing are heated at 450° C. in the atmosphere. Thereby, the organic material is decomposed and removed, and then a phosphor film is obtained.

The thickness of the phosphor film is preferably equal to thickness of 2 to 4 particles of the phosphor particles 21. With the thickness falling within this range, highest brightness is obtained when the film is used in an image display device. The phosphor film preferably has a thickness equal to thickness of 2 to 3 particles of the phosphor particles. Specifically, the thickness of the light-emitting layer preferably falls within a range of 8 μm to 12 μm.

A boron nitride film 22 is formed by PLD on the phosphor film made of an assembly of the phosphor particles 21.

The glass substrate on which the phosphor film is formed is placed in a vacuum chamber, and the chamber is evacuated to a vacuum of 10⁻² Pa or less. A nitrogen gas is introduced into the evacuated chamber to obtain a pressure of about 0.1 to 10 Pa. Yttrium aluminum garnet (YAG) 266 nm is used as a laser source, and laser beam is introduced into the chamber from the outside and applied to an h-BN target. The laser radiation energy can be selected as desired within a range of 10 to 100 mJ/pulse. The thickness of the deposited boron nitride film can be changed by changing the radiation duration.

From a practical standpoint of image display devices, the thickness of the deposited boron nitride film 22 is preferably 20 nm or less. To obtain an effect for aging, the boron nitride film 22 may be formed with a thickness of about 80 nm.

Since it is formed by PLD, the boron nitride film 22 is also deposited on the substrate 5, as illustrated in FIG. 4. The boron nitride film 22 on the substrate 5 can be removed if necessary. For example, the surface of the substrate 5 is coated with a resist film or the like in advance. After the boron nitride film 22 is deposited, the boron nitride film 22 on the substrate 5 can be easily removed by removing the resist film.

PLD is a method of applying a laser pulse to a target material such as organic material as well as inorganic material, and depositing the decomposed target substance. By applying laser to the target, a plasma target substance having a high energy density is generated. In PLD, since the target can be instantly transformed into plasma, a thin film having the same composition as the target is formed. The thickness of the thin film can be changed according to radiation duration, energy, the type of atmosphere gas, the pressure of the gas, and distance between the target and the material to be coated.

A thin film of high quality is formed by PLD. Further, according to PLD, a thin film having the same composition as that of the target is formed. Therefore, energy required when the material to be coated is coated with the target material is low, and damage to the coated material is small.

When phosphor containing zinc sulfide is used in the light-emitting layer, in an image display device having an electron source substrate having cold cathode electron-emitter elements which emit electrons and an anode substrate having a light-emitting layer which is excited by electrons and emits light and an anode which applies voltage to the light-emitting layer, the penetration depth of electrons into phosphors correlates with electron acceleration. In a region where the acceleration voltage is relative low, for example, 5 kV, the penetration depth is about several hundred nm, and the light-emitting property is greatly influenced by the surface property of a phosphor, such as defects. Therefore, PLD is preferable as a method not damaging the surfaces of phosphors.

Since a boron nitride film is formed by PLD on the zinc sulfide-based phosphor film, early deterioration in brightness is prevented. Specifically, the embodiment has an effect of shortening aging.

As described above, PLD is a method of forming a thin film, in which a pulse laser is applied to a target material, and atoms, molecules or fine particles released by instant sublimation of the target material. Although boron nitride is a material having a bandgap of about 6 eV and a melting point exceeding 3000° C., it can be deposited on the substrate by PLD even under an environment of room temperature. The material subjected to ablation is changed into a plasma state called plume, and then deposited on the substrate. It is considered that light having a wavelength less than the near-ultraviolet region is generated when the plasma state is generated. Further, it has been confirmed that a ZnS phosphor film emits light during PLD processing.

Generally known is a UV cleaning method in which the surfaces of phosphors are cleaned by applying ultraviolet light. The inventor(s) of the present invention has already confirmed that only applying ultraviolet rays to phosphors cannot produce an effect of preventing early deterioration in brightness, that is, an effect of shortening aging. Therefore, the effect of shortening aging is not caused by UV cleaning which is generally performed, but by a boron nitride film formed by PLD on the phosphor film.

The following is explanation of the present invention based on examples.

### EXAMPLE 1

First, a zinc sulfide-based phosphor film was formed on a glass substrate of 10 mm×10 mm by precipitation. The phosphor actually used was ZnS: Cu, Al, and it was confirmed by blaine air permeability method that the average particle diameter of the phosphor was about 5 μm.

To adhere phosphors on the glass substrate, barium silicate obtained by reacting a Ba(NO₃)₂ aqueous solution with a water glass aqueous solution was used as a binder. Phosphor particles were dispersed in the water glass and sufficiently stirred.

On the other hand, the glass substrate was immersed and kept stationary in a barium nitrate aqueous solution, and the water glass including dispersed phosphor particles was mixed into the solution. The phosphor precipitated with a reaction product of barium nitrate and water glass formed a film on the glass substrate, and thereby a film substrate was obtained. The substrate was dried at 120° C. to remove moisture, and thereby the phosphor film was prepared.

The glass substrate having the phosphor film was placed in a vacuum chamber, and the chamber was evacuated to a vacuum of 10⁻² Pa or less. After evacuation, a nitrogen gas was introduced into the chamber, and pressure was increased to 0.1 to 10 Pa. YAG 266 nm was used as a laser source, and laser beam was introduced into the chamber from the outside and applied to an h-BN target. The laser beam was applied for 20 minutes with a radiation energy of 10 mJ/pulse. Thereby, a boron nitride film was formed on the phosphor film, and thereby a sample was obtained. The thickness of the boron nitride film was measured by using a quartz-crystal coating thickness gauge. The thickness of the boron nitride film was 20 nm.

### COMPARATIVE EXAMPLE 1

Phosphor particles which are the same as those used in Example 1 were prepared, and subjected to surface treatment by phosphate. Specifically, first, 41 g of Graham salt (manufactured by Merck) was added to 5000 mL of water, and stirred for one hour. The solution was passed through a G3 glass filter (manufactured by Shott), and thereby a solution was obtained. 2000 g of ZnS: Ag, Al phosphor was suspended in the solution, and cleaned twice by a dilute sodium hydroxide solution. Further, the phosphor was cleaned by acetone, and dried at 140° C., and thereby surface-treated phosphor was obtained.

A sample was obtained by forming a phosphor film on a glass substrate of 10 mm×10 mm by the same method as in Example 1, except for using the surface-treated phosphor prepared as described above.

### COMPARATIVE EXAMPLE 2

Phosphor particles which are the same as those in Example 1 were prepared, and a boron nitride film was formed on the particles by PLD. Specifically, first, the phosphor particles are put into a laboratory dish, and placed in a vacuum chamber. Laser beam was applied to an h-BN target under the same conditions as in Example 1, except for vibrating the dish by a vibrator. Boron nitride was formed on the surfaces of the phosphor particles by irradiation for 20 minutes.

A sample was obtained by forming a phosphor film on a glass substrate of 10 mm×10 mm by the same method as in Example 1, except for using the surface-treated phosphor prepared as described above.

As illustrated in FIG. 5, in the phosphor film in Comparative Example 2, each of the phosphor particles 21 is coated with boron nitride 24. Since the phosphor particles are subjected to surface treatment before they are deposited as a film, it is clear that boron nitride 24 is not formed as a film on the substrate 25.

### COMPARATIVE EXAMPLE 3

A sample was obtained by forming a phosphor film on a glass substrate of 10 mm×10 mm by the same method as in Example 1, except for using Y₂SiO₅-based phosphor having an average particle diameter of about 5 μm.

Aging by electron beam irradiation was evaluated for each of samples of Example 1 and Comparative Examples 1 to 3. The applied voltage in radiation was 10 kV, and the phosphor surface was subjected to raster evaluation with 70 Hz by an electron beam. The current density of the applied electron beam was about 6.5 mA/cm².

The following Table 1 shows evaluation results. The brightness maintenance ratio indicates brightness when a charge injection amount is 0.1 C/cm² supposing that the brightness directly after start of evaluation is 100%. The brightness maintenance ratio 100% indicates that no deterioration was observed.

TABLE 1

| | | Brightness |
|---|---|---|
| | Radiation time | maintenance |
| | (minutes) | ratio (%) |
| Example 1 | 20 | 100 |
| Example 2 | 40 | 100 |
| Example 3 | 80 | 100 |
| Comparative | — | 90 |
| Example 1 | | |
| Comparative | 20 | 80 |
| Example 2 | | |
| | 120 | 85 |
| Comparative | — | 100 |
| Example 3 | | |

As shown in Table 1, forming a boron nitride film by PLD on the phosphor film enables substantial prevention of deterioration in brightness. In comparison with this, in the case of performing surface treatment by phosphate (Comparative Example 1), deterioration of 10% occurred without injection of electric charge. In the case of adhering boron nitride particles to phosphor particles (Comparative Example 2), deterioration of 20% occurred by electric beam radiation for 20 minutes.

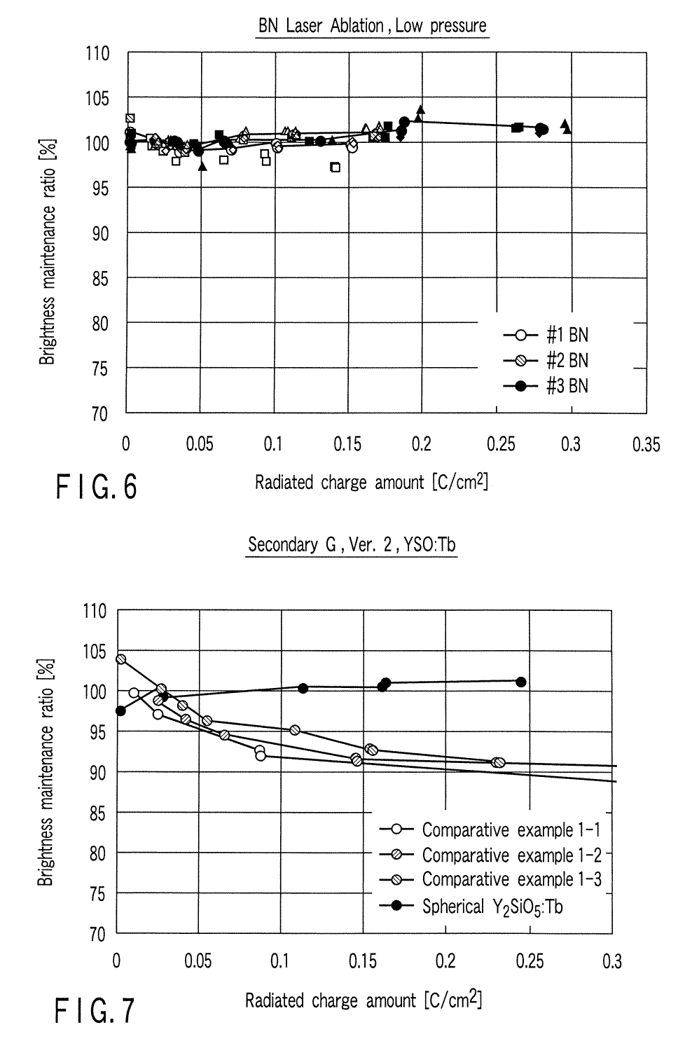

In FIG. 6, #1BN, #2BN, and #3BN indicate states of deterioration of Example 1, Example 2, and Example 3, respectively. As illustrated in FIG. 6, since a boron nitride film is formed by PLD after a ZnS phosphor film is formed, no deterioration in aging is observed. Therefore, it has been proved that aging is almost unnecessary.

As illustrated in FIG. 7, in the case of using Y₂SiO₅-based phosphor, no deterioration is observed even when a boron nitride film is not formed by PLD. It has been proved that coating by a boron nitride film is effective when it is applied to ZnS phosphor.

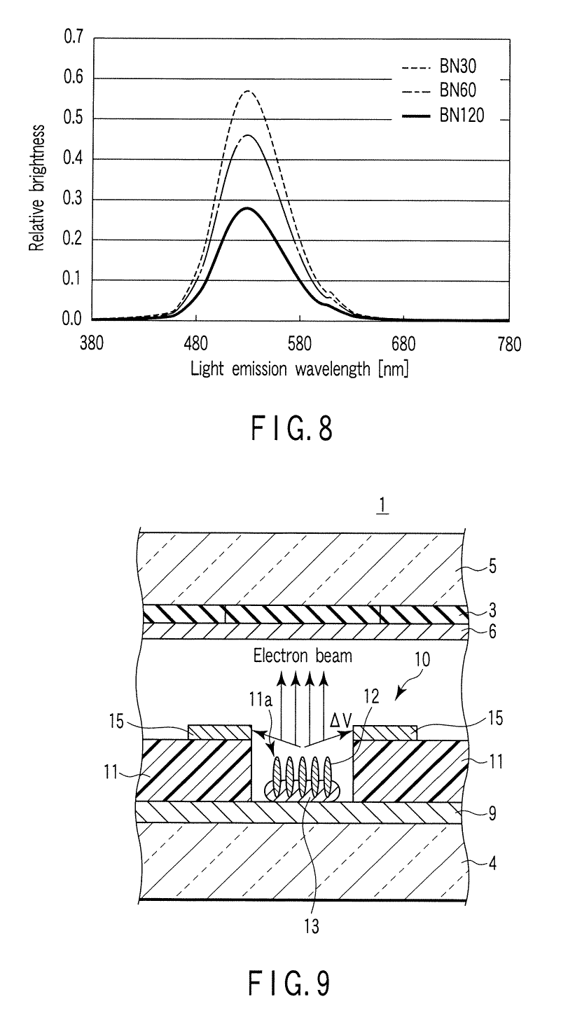

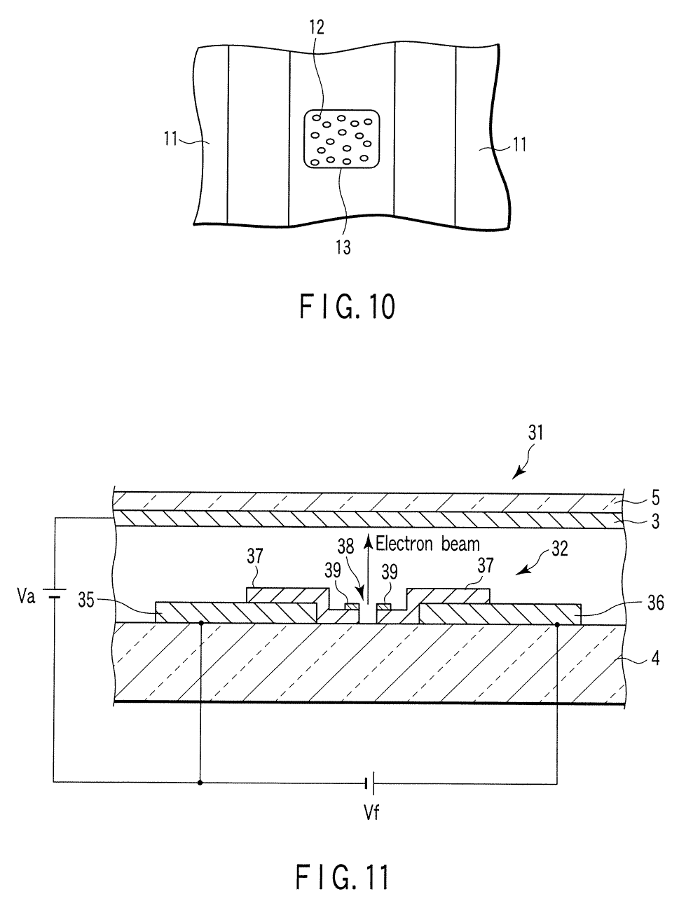

Next, samples having respective boron nitride films of different thicknesses were prepared by the same method as in Example 1, except for changing the duration of applying laser. The durations were 30, 60, and 120 minutes. The thicknesses of the boron nitride films corresponding to the respective durations were 20, 40, and 80 nm, respectively. As illustrated in FIG. 8, the brightness increases as the duration decreases, that is, as the thickness of the boron nitride film decreases. When the thickness of the boron nitride film is 40 nm or less, more excellent product property is obtained.

### EXPERIMENT EXAMPLE 1

A zinc sulfide-based phosphor film was formed on a glass substrate of 10 nm×10 nm by the same method as in Example 1. The glass substrate having the phosphor film was placed in a chamber, and a silicon nitride film was formed on the phosphor film by the same method as in Example 1, except for changing the target to an Si₃N₄ target. Thereby, a sample was obtained. The radiation duration of laser was 30 minutes.

Aging evaluation was performed for the prepared sample under the same conditions as in Example 1. As a result, when the injection charge amount was 0.1 C/cm², the brightness maintenance ratio was 94%.

### EXPERIMENT EXAMPLE 2

A zinc sulfide-based phosphor film was formed on a glass substrate of 10 nm×10 nm by the same method as in Example 1. The glass substrate having the phosphor film was placed in a chamber, and a titanium oxide film was formed on the phosphor film by the same method as in Example 1, except for changing the target to a TiO₂ target. Thereby, a sample was obtained. The radiation duration of laser was 30 minutes.

Aging evaluation was performed for the prepared sample under the same conditions as in Example 1. As a result, when the injection charge amount was 0.1 C/cm², the brightness maintenance ratio was 92%.

### EXPERIMENT EXAMPLE 3

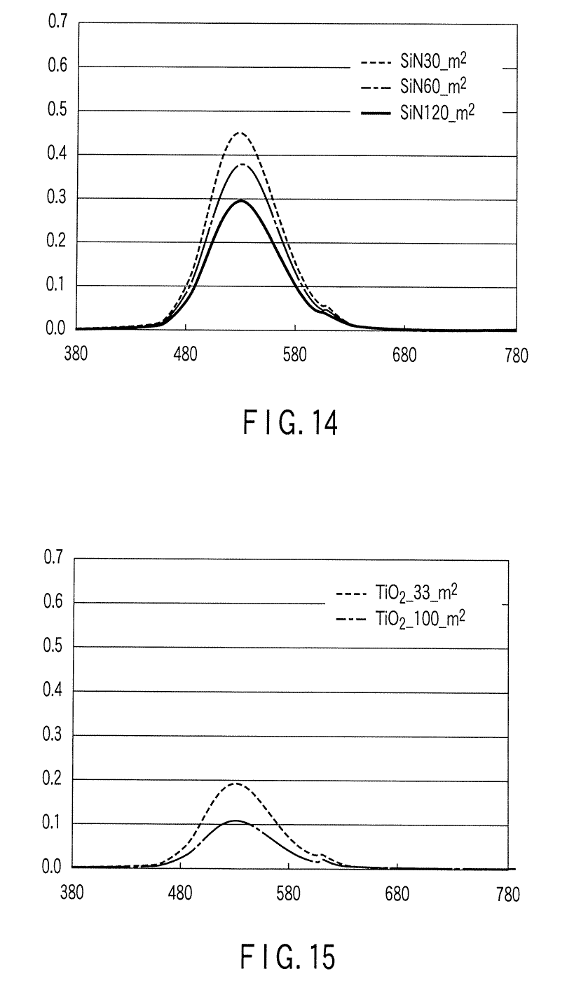

Samples were prepared by forming a silicon nitride film on the phosphor film by the same method as in Experiment Example 1, except for varying the laser radiation duration. The radiation durations of laser were 30, 60, and 120 minutes. The thicknesses of the silicon nitride films corresponding to the respective durations were 20, 40, and 80 nm, respectively. As illustrated in FIG. 14, the brightness increases as the radiation duration decreases, that is, as the thickness of the silicon nitride film decreases.

### EXPERIMENT EXAMPLE 4

Samples were prepared by forming a titanium oxide film on the phosphor film by the same method as in Experiment Example 2, except for varying the laser radiation duration. The radiation durations of laser were 30 and 100 minutes. The thicknesses of the silicon nitride films corresponding to the respective durations were 17 and 40 nm, respectively. As illustrated in FIG. 15, the brightness increases as the radiation duration decreases, that is, as the thickness of the titanium oxide film decreases.

As illustrated in FIG. 9, the display device according to the embodiment is a field-emission display (FED) which uses carbon nanotubes 12 being bar-shaped carbon molecules as an electron source, and zinc sulfide-based phosphor is used for the display.

The carbon nanotubes 12 are very minute substances having a diameter of several nanometers.

In the display device, the rear substrate 4 provided with the emitter elements 10 to emit electrons is opposed to the face substrate 5 provided with the phosphor film 3. As described above, the phosphor film 3 emits light by being struck by electrons emitted from the emitter elements 10. The sidewall is disposed between the rear substrate 4 and the face substrate 5, and the inside space is maintained under vacuum. The face substrate 5 is formed of, for example, a glass substrate and the phosphor film 3 is formed on a surface of the face substrate 5 opposed to the substrate 4. Further, the aluminum film 6 is formed as an anode on the phosphor film 3.

In the phosphor film 3, phosphors of three primary colors, that is, red (R), green (G), and blue (B), are applied in a stripe manner by subsequently repeating slurry application, exposure, and development. The green and blue phosphors are mainly formed of zinc sulfide, and contain at least one of copper (Cu), gold (Au), and silver (Ag) as an activator, and at least one of aluminum (Al), chlorine (Cl), bromine (Br), and iodine (I) as a co-activator. The red phosphor is a rare-earth oxysulfide phosphor such as yttrium oxysulfide (Y₂O₂S: Eu). The red, blue and green phosphors may be arranged in a dotted manner. The phosphor film 3 may be formed by spraying or printing.

Black conductors (not shown) are alternated with stripes of the phosphors. By providing the black conductors, it is possible to suppress a shift in display color even when there is a slight displacement the radiation position of the electron beam. Further, the black conductors have a function of preventing reflection of external light to prevent decrease in display contrast, and preventing charging of the phosphor film due to electron beam. The black conductors can be mainly formed of, for example, graphite, or other materials which produce a similar effect.

As explained above with reference to FIG. 1, the emitter elements 10 which emit electrons are provided in association with the respective red, blue, and green phosphors. FIG. 9 illustrates one of the emitter elements. In the emitter element 10, a cathode 9 and an insulating material 11 are successively stacked, and an opening portion 11a is formed in the insulating material 11. Thereby, a predetermined area of the cathode 9 is exposed to the phosphor film 3 through the opening portion 11a.

Examples of the substrate 4 are glass substrates such as quartz glass and soda-lime glass, and ceramic substrates such as alumina. As another example, a substrate obtained by superposing an insulating layer formed of silicon oxide (SiO₂) or the like on the above substrate may be used.

The cathode 9 in the opening portion 11a is provided with the carbon nanotubes 12 being an electron source over a predetermined range. The carbon nanotubes 12 can be fixed to the cathode 9 by the following method, for example. First, an Ni catalyst serving as a growth starting point of the carbon nanotubes 12 is dripped into the opening portion 11a, to remove organic substances. Then, the carbon nanotubes 12 are grown in hydrocarbon gas plasma. By the above method, the carbon nanotubes 12 are arranged in a distributed manner on the surface of the conductive film 13 at a certain rate.

The carbon nanotubes 12 being an electron source form an electron emission area of a certain range on the substrate 4 opposed to the phosphor film 3.

Tip portions of the carbon nanotubes 12 fixed to the conductive film 13 project from the surface of the conductive film 13. An element application voltage Vf (potential difference ΔV) is applied between the projecting portions and a control electrode (gate electrode) 15, and thereby electrons are emitted from the tip portions of the carbon nanotubes 12. The emitted electrons are accelerated by an acceleration voltage Va applied between the cathode 9 and the anode (metal back layer 6) of the phosphor film 3, and collide with the phosphor film 3. The phosphor film 3 emits light by the collision of electrons.

As described above, the phosphor film 3 includes three types of phosphors, that is, red, green, and blue. At least one of the green phosphor and the blue phosphor is a zinc sulfide-based phosphor, and a boron nitride film formed by PLD exists on the surface of the phosphor film. The metal back layer 6 on the phosphor film 3 was prepared by the following method, using aluminum.

First, a base film (having a thickness of 20 μm) formed of polyester was prepared, and a mold release agent layer was formed thereon by using silicone. The thickness of the mold release agent layer was 0.5 μm. An aluminum film having a thickness of 50 nm was formed on the mold release agent layer by vacuum plating. Further, an adhesive layer was formed on the aluminum film by using a resin composition containing 90 parts of toluene and 10 parts of vinyl acetate. The adhesive layer was obtained by applying the resin composition by a gravure coater and drying the resin.

The adhesive layer was disposed in contact with the phosphor layer having the boron nitride film, and then pressed and bonded by a rubber roller (transfer roller) having a surface temperature of 200° C. Then, the base film was removed, and thereby the aluminum film was transferred to the phosphor layer having the boron nitride film. Lastly, the substrate was heated and baked at 450° C. to decompose and remove the organic component, and thereby the face substrate 5 was finished.

In the embodiment, the green and blue phosphors mainly formed of zinc sulfide are coated with the boron nitride film formed by PLD. Thereby, even when the phosphors are exposed to electron beams of high density, early deterioration (aging) due to adsorbed gas is suppressed.

Another coating layer for the phosphor film may exist, as long as the phosphor film is coated with a boron nitride film. For example, a coating layer can be formed by a phosphate compound (magnesium metaphosphate (Mg(PO₃)₂), trimagnesium phosphate (Mg₃(PO₄)₂), or magnesium pyrophosphate (Mg₂P₂O₇).

According to the display panel of the embodiment, phosphor aging time was shortened to half the time of the prior art, as a result of applying electron beams of 10 kV radiation energy.

The display device 31 illustrated in FIG. 11 has a structure, in which a substrate 4 provided with a film-shaped emitter element 32 being an electron source to emit electrons is opposed to a face substrate 5 provided with a phosphor film 3 emitting light by collision with electrons emitted from the emitter element 32. A space between the substrate 4 and the face substrate 5 is sealed by a sidewall (not shown) provided around the substrate 4 and the face substrate 5, and maintained under vacuum. The face substrate 5 is formed of, for example, a glass substrate.

As described above, at least one of a green phosphor film and a blue phosphor film is formed of zinc sulfide-based phosphor, and a surface thereof is coated with a boron nitride film. Further, a red phosphor is mainly formed of yttrium oxysulfilde (Y₂O₂S). The red, green, blue phosphors may be arranged in a dotted manner. Further, black conductors are provided between respective stripes of the phosphors.

A plurality of emitter elements 32 to emit electrons are provided on the substrate 4 in association with the red, green, and blue phosphors. FIG. 11 illustrates one of the emitter elements. Each of the emitter elements 32 has element electrodes 35 and 36 formed on the substrate 4, a conductive thin film 37 formed to spread over the surface of the substrate 4 and the surfaces of the element electrode 35 and 36, a crack-shaped electron emission portion 38 formed in the conductive thin film 37 by energizing forming, and a thin film 39 formed on the surface of the conductive thin film 37 and on both sides of the electron emission portion 38 by energizing activation. The electron emission portion 38 forms an electron emission region of a predetermined range on the substrate 4.

Examples of the substrate 4 are glass substrates such as quartz glass and soda-lime glass, and ceramic substrates such as alumina. As another example, a substrate obtained by superposing an insulating layer formed of silicon oxide (SiO₂) or the like on the above substrate may be used.

The element electrodes 35 and 36 opposed to each other on the substrate 4 are formed of a conductive material. The material of the element electrodes 35 and 36 can be selected according to necessary from, for example, metal such as nickel (Ni), chromium (Cr), gold (Au), molybdenum (Me), tungsten (W), platinum (Pt), titanium (Ti), copper (Cu), palladium (Pd), and silver (Ag), an alloy of these metals, a metal oxide such as In₂O₃—SnO₂, and semiconductor such as polysilicon.

The element electrodes 35 and 36 can be formed by a combination of a film formation technique such as vacuum plating and a patterning technique such as photolithography and etching. The element electrodes may be formed by using another method such as printing. The shape of the element electrodes is properly designed in accordance with the structure of the display device 31.

The distance L between the element electrodes 35 and 36 preferably falls within a range from several dozen nanometers to several hundred μm, more specifically within a range from several μm to several dozen μm. The thickness D of the element electrodes 35 and 36 preferably falls within a range from several dozen nm to several μm.

A fine-grain film can be used as the conductive thin film 37. The grain diameter of fine grains used for the fine-grain film preferably falls within a range from several to several hundred nm. In the embodiment, the fine-grain film is formed by using fine grains having a grain diameter within a range from several nm to 20 nm.

The thickness of the fine-grain film can be properly set in consideration of conditions necessary for establishing an electrically good connection with the element electrodes 35 and 36, conditions necessary for smoothly performing energizing forming, and conditions necessary for setting the electric resistance of the fine-grain film itself to a predetermined value. Specifically, the thickness of the fine-grain film falls within a range from several to several hundred nm. In the embodiment, the thickness is set to a range from 1 to 50 nm.

To form the conductive thin film 37, it is possible to use, for example, metal such as palladium (Pd), platinum (Pt), ruthenium (Ru), silver (Ag), gold (Au), titanium (Ti), indium (In), copper (Cu), chromium (Cr), iron (Fe), zinc (Zn), tin (Sn), tantalum (Ta), tungsten (W), and lead (Pb), an oxide such as PdO, SnO₂, In₂O₃, PbO, and Sb₂O₃, a boride such as HfB₂, ZrB₂, LaB₆, CeB₆, YB₄, GdB₄, a carbide such as TiC, ZrC, HfC, TaC, SiC, and WC, a nitride such as TiN, ZrN, and HfN, a semiconductor such as silicon (Si) and germanium (Ge), and carbon.

The sheet resistance value of the conductive thin film 37 was set to a range from 10³ to 10⁷Ω/cm².

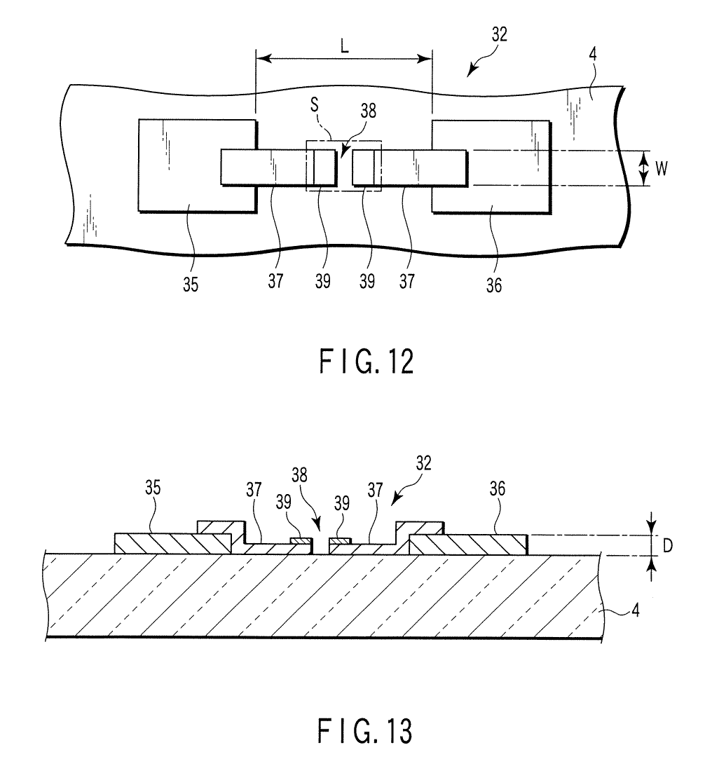

Since it is preferable that the conductive thin film 37 has a good electrical connection with the element electrodes 35 and 36, the conductive thin film 37 and the element electrodes 35 and 36 are configured to overlap each other. Although the conductive thin film 37 is layered on the element electrodes 35 and 36 in the example of FIG. 12, the element electrodes 35 and 36 may be formed on the conductive thin film 37.

The electron emission portion 38 is a crack-shaped portion formed in a part of the conductive thin film 37, and has an electric resistance value higher than the surrounding conductive thin film 37. The crack can be formed by performing energizing forming for the conductive thin film 37. In the energizing forming, the conductive thin film 37 formed of a fine-grain film is energized, and a part of the conductive thin film 37 is broken, deformed, and altered. Thereby, the part is changed to a structure suitable for performing electron emission. There are cases where fine grains having a grain diameter of from several to several dozen nm are disposed in the crack.

The thin film 39 is formed of carbon or a carbon compound, and covers the electron emission portion 38 and surrounding parts. The thin film 39 can be formed by energizing activation after energizing forming. In energizing activation, a voltage pulse is periodically applied in vacuum atmosphere. Thereby, carbon or a carbon compound originated from an organic compound existing in the vacuum atmosphere is deposited. The deposited substance can be formed by at least one selected from monocrystalline graphite, polycrystalline graphite, and amorphous graphite. The thickness of the thin film 39 is preferably 50 nm or less, more preferably 30 nm or less.

In the above display device 31, a voltage of 10 to 20V (Vf) is applied between the element electrodes 35 and 36, thereby electrons are emitted from one end of the crack-shaped electron emission portion 38 formed on the conductive thin film 37, and part of the electrons are scattered by the other end of the electron emission portion 38. The dispersed electrons are accelerated by an anode voltage Va of about 10 kV, and collide with the phosphors of the phosphor film 3. By this collision, the phosphors emit light.

In the embodiment, the green and blue phosphor films mainly formed of zinc sulfide are coated with a boron nitride film formed by PLD. Thereby, even when the phosphors are exposed to electron beams of high density, early deterioration (aging) due to adsorbed gas is suppressed.

As described above, as along as the phosphor film is coated with a boron nitride film, another coating layer may exist. For example, another coating layer may be formed by a phosphate compound (magnesium metaphosphate (Mg(PO₃)₂), trimagnesium phosphate (Mg₃(PO₄)₂), or magnesium pyrophosphate (Mg₂P₂O₇).

According to the display panel of the embodiment, phosphor aging time was shortened to half the time of the prior art, when electron beams of 10 kV radiation energy were applied.

According to the embodiment, there is provided an image display device in which the speed of early deterioration in brightness life thereof is reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display device comprising:
a first substrate having a cold-cathode electron-emission element which emits electrons; and
a second substrate which is spaced from and opposed to the first substrate, the second substrate having a transparent substrate, a light-emitting layer provided on the transparent substrate and including phosphor particles containing zinc sulfide as a base material, a boron nitride film disposed on a surface of the light-emitting layer, and an anode applying a voltage to the light-emitting layer.

2. The image display device according to claim 1, wherein the phosphor particles contain at least one activator selected from a group consisting of Cu, Au, and Ag, and at least one co-activator selected from a group consisting of Al, Cl, Br, and I.

3. The image display device according to claim 1, wherein the phosphor particles contain one selected from a group consisting of ZnS: Cu. Al, ZnS: Ag. Al, ZnS: Ag. Al. Au, and ZnS: Ag. Cl.

4. The image display device according to claim 1, wherein an average particle diameter of the phosphor particles is 2 μm to 10 μm.

5. The image display device according to claim 1, wherein an average particle diameter of the phosphor particles is 5 μm to 6 μm.

6. The image display device according to claim 1, wherein the phosphor particles are formed of ZnS: Cu. Al having an average particle diameter of 5 μm.

7. The image display device according to claim 1, wherein the light-emitting layer has a thickness corresponding to 2 particles to 4 particles of the phosphor particles.

8. The image display device according to claim 1, wherein the boron nitride film has a thickness of 80 nm or less.

9. The image display device according to claim 1, wherein the boron nitride film has a thickness of 20 nm or less.

10. The image display device according to claim 1, wherein the boron nitride film also exists directly on the transparent substrate.

11. A method for manufacturing an image display device comprising:
forming a light-emitting layer including phosphor particles containing zinc sulfide as a base material on a glass substrate for an anode; and
forming a boron nitride film on the light-emitting layer by pulse laser deposition.

12. The method according to claim 11, wherein the phosphor particles contain one selected from a group consisting of ZnS: Cu. Al, ZnS: Ag. Al, ZnS: Ag. Al. Au, and ZnS: Ag. Cl.

13. The method according to claim 11, wherein an average particle diameter of the phosphor particles is 2 μm to 10 μm.

14. The method according to claim 11, wherein the light-emitting layer has a thickness corresponding to 2 particles to 4 particles of the phosphor particles.

15. The method according to claim 11, wherein the light-emitting layer is prepared by precipitation or printing.

16. The method according to claim 11, wherein the pulse laser deposition is performed by using a YAG laser as a light source.

17. The method according to claim 11, wherein the pulse laser deposition is performed at a pressure from 0.1 Pa to 10 Pa.

18. The method according to claim 11, wherein the pulse laser deposition is performed with energy from 10 mJ/pulse to 100 mJ/pulse.

19. The method according to claim 11, wherein the boron nitride film is formed with a thickness of 80 nm or less.
